(19) United States
(12) Patent Application Publication
(10) Pub. No.: US 2002/0084174 A1
(43) Pub. Date: Jul. 4, 2002

(54) Soft drop preform conveyor system

(76) Inventor: Maurice Minardi, Dudley, MA (US)

Correspondence Address: Mirick, O'Connell,, DeMallie & Lougee, LLP, 1700 West Park Drive, Westborough, MA, 01581-3941, US

(21) Appl. No.: 10/006,749

(22) Filed: Dec. 5, 2001

Related U.S. Application Data
(60) Provisional application No. 60/259,111, filed on Dec. 29, 2000.

(51) Int. Cl. B65G 21/00; B65G 41/00

(52) U.S. Cl. 198/861.2

(57) ABSTRACT

A soft drop preform conveyor system for loading preforms into an open-top container. The system includes a conveyor having a preform loading end, and a distal end from which preforms leave the conveyor, the conveyor moving preforms from outside of the container, over the lip of the container, and down into the container, close to the product level within the container. The product level height within the container is sensed. The height of the distal end of the conveyor is altered, between a lowest position in which the distal end is near the bottom of the container, and a highest position in which the distal end is higher within the container, or just above the container. The system includes a control system, responsive to the sensed product level, for controlling the conveyor distal end height, to maintain the conveyor distal end close to the product level within the container, so that preforms drop only a short distance from the conveyor into the container.

### FIELD OF THE INVENTION

This invention relates to a conveyor system that is designed specifically to convey soft drink and similar bottle preforms from an injection molding machine to storage containers.

### BACKGROUND OF THE INVENTION

In the manufacture of plastic soft drink bottles and the like, typically made of PET, bottle preforms are first injection molded. The preforms are then later blow molded to the final product configuration.

The preforms are typically moved from the molding machine to a storage container by first traveling on a conveyor with a discharge chute that feeds a second conveyor that raises the preforms from floor level up to and over the top lip of the storage container, which is typically approximately 4 feet high. The preforms drop off the end of the conveyor and fall into the container. The impact of the preforms falling into the container can cause nicks and marks in the screw top threads, and in the body of the preforms. Nicks in the threads can cause the bottles to leak, and marks are unsightly. Accordingly, such nicks and marks should be avoided.

### SUMMARY OF THE INVENTION

The invention herein comprises a conveyor system for preforms that drops the preforms only inches rather than feet. This reduces problems created as described above.

The invention is accomplished with an inverted “L” shaped conveyor that conveys the preforms from around the floor level up and over the lip of a container, and then down close to the product level in the container being filled. The invention includes means for determining the product level in the container, and in response raising the end of the conveyor to maintain the conveyor end slightly above the product fill level.

This invention features a soft drop preform conveyor system for loading preforms into an open-top container, comprising a conveyor having a preform loading end, and a distal end from which preforms leave the conveyor, the conveyor moving preforms from outside of the container, over the lip of the container, and down into the container, close to the product level within the container, means for sensing the product level height within the container, means for altering the height of the distal end of the conveyor, between a lowest position in which the distal end is near the bottom of the container, and a highest position in which the distal end is higher within the container, or just above the container, and a control system, responsive to the product level sensing means, for controlling the conveyor distal end height, to maintain the conveyor distal end close to the product level within the container, so that preforms drop only a short distance from the conveyor into the container.

The means for sensing may comprise an ultrasonic sensor system. The means for altering may comprise an electric linear actuator. The conveyor system may further comprise at least two containers proximate one another. The conveyor system in this case may further comprise means for moving the conveyor such that its distal end can be located within either container. The means for moving may then comprise means for pivoting the conveyor about an axis.

The conveyor loading end may be below the top of the container. The conveyor may have a proximal section conveying preforms up over the lip of the container, and a distal section conveying preforms down into the container. The conveyor may have a conveyor belt, in which case the conveyor system may farther comprise means for adjusting the speed of the conveyor belt to run temporarily faster when a container is almost full, to clear preforms from the container, and to run temporarily slower after running temporarily faster, to accumulate preforms in the container while the conveyor distal end is being moved between containers.

In a more specific embodiment, the invention features a soft drop preform conveyor system for loading preforms into an open-top container, comprising at least two containers proximate one another, a conveyor having a preform loading end, and a distal end from which preforms leave the conveyor, the conveyor moving preforms from outside of the container, over the lip of the container, and down into the container, close to the product level within the container, an ultrasonic sensor system for sensing the product level height within the container, an electric linear actuator system for altering the height of the distal end of the conveyor, between a lowest position in which the distal end is near the bottom of the container, and a highest position in which the distal end is higher within the container, or just above the container, means for moving the conveyor such that its distal end can be located within either container, and a control system, responsive to the product level sensing means, for controlling the conveyor distal end height, to maintain the conveyor distal end close to the product level within the container, so that preforms drop only a short distance from the conveyor into the container.

### BRIEF DESCRIPTION OF THE DRAWINGS

Other objects, features and advantages will occur to those skilled in the art from the following description of the preferred embodiments and the accompanying drawings in which:

FIG. 1 is a partial side schematic view of the preferred embodiment of the soft drop preform conveyor system of this invention; and

FIG. 2 is a top schematic view of the invention.

### DETAILED DESCRIPTION OF THE PREFERRED EMBODIMENTS

This invention may be accomplished in a soft drop preform conveyor system that is used for loading preforms into open-top containers. The system includes a conveyor. Preforms are loaded onto a loading end of the conveyor, and leave the conveyor at its distal end. The conveyor moves the preforms from outside of the container, over the lip of the container, and down into the container close to the product level within the container.

The system also includes means for sensing the product level height within the container. The system still further includes means for altering the height of the distal end of the conveyor, between a lowest position in which it is near the bottom of the container, and a highest position in which it is higher within the container, or just above the container. The inventive conveyor system also includes a control system that is responsive at least to the product level sensed by the sensing means. The control system controls the distal end height in response to the sensed product level to maintain the conveyor distal end close to the product level within the container, so that preforms drop only a short distance from the conveyor into the container.

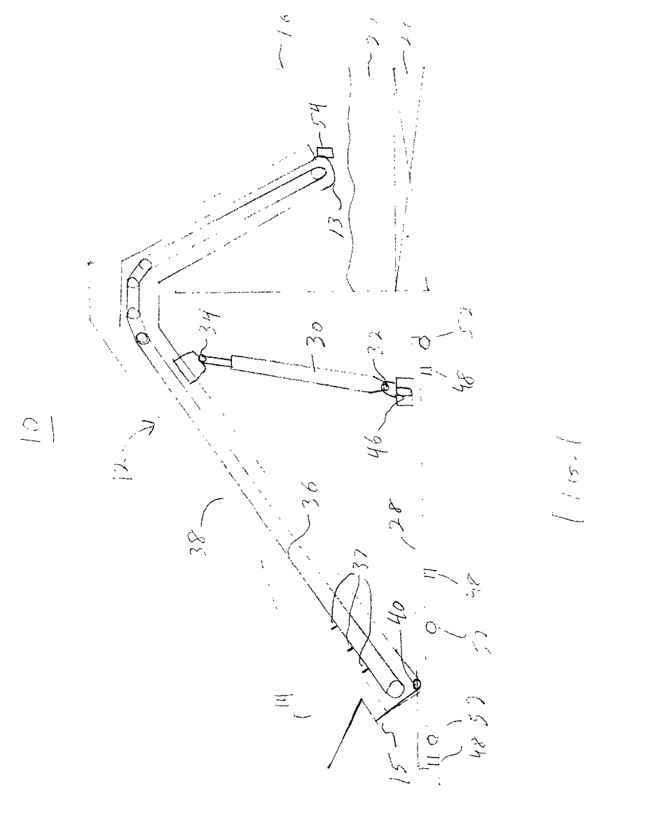

FIG. 1 is a partial side view of the preferred embodiment of the inventive soft drop preform conveyor system. System 10 comprises conveyor 12. Preforms from a preform molding machine (not shown in the drawings) are loaded into hopper 14 that is near proximal end 15 of conveyor 12. Conveyor belt 36 having spaced cleats 37 moves the preforms to distal end 13 of conveyor 12. At this point, the preforms fall from the conveyor into container 16 that is on top of skid 24. Level 20 is meant to depict the level of the partially filled container 16 into which preforms are being dropped.

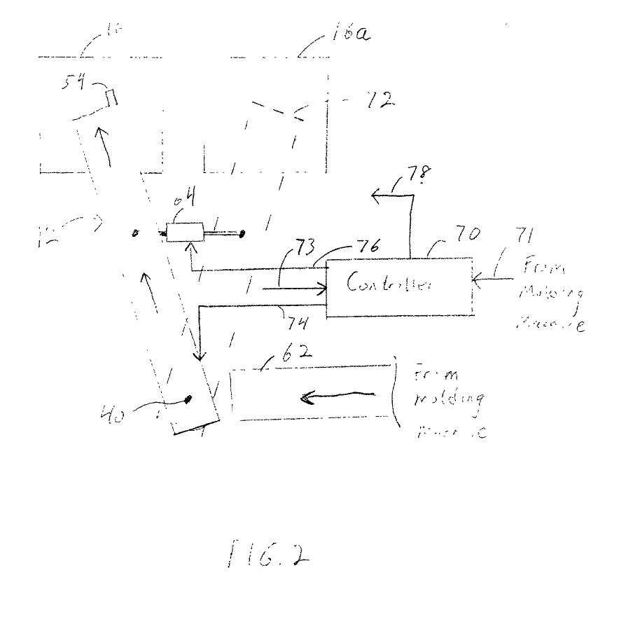

System 10 also includes means for sensing the product level height within the container. This can be accomplished by contact means such as switches that are closed as the container is filled, or non-contact means such as electromagnetic or ultrasonic sensors, for example. In the preferred embodiment, ultrasonic level sensor system 54 is used to sense the product level height within container 16. Sensor system 54 is preferred because ultrasonic sensors are able to detect the distance from the sensor to an object in environments in which the individual parts can be of different colors, different surface reflectivities, and there are different arrangements of the pile as it increases in height within the container. The output of sensor system 54 is used by controller 70, FIG. 2, to properly adjust the height of conveyor distal end 13 so that the preforms drop a short distance of only inches from the conveyor to pile 20. This inhibits nicking and scratching of the preforms that occurs when the product is conveyed over the lip of the container and dropped therefrom to the product pile.

In order to accomplish this end, there is a need for automatically, vertically moving conveyor 12 such that distal end 13 can be located very close to the bottom of container 16, and move up closer to, or just slightly higher than, the open top of container 16. This means for altering the height of the distal end of the conveyor is preferably accomplished with electric linear actuator 30 driven by a motor, not shown in the drawing. An electric linear actuator is preferred over pneumatic or hydraulic actuators because an electric linear actuator is capable of smooth, precise positioning. This results in a very precise positioning of the distal end of the conveyor, and its movement in a smooth manner. If the vertical motion of the conveyor included sudden movements, the parts being carried by the conveyor could be subject to premature dropping and thus damage. Electric linear actuator 30 is mounted such that it pivots about points 32 and 34. As the conveyor 12 is raised to a higher position, conveyor 12 pivots on point 40 relative to support platform 28.

The system of the invention is preferably enabled to continuously load preforms from a preform molding machine into two side-by-side containers. The preferred arrangement for accomplishing this is schematically depicted in FIG. 2. Containers 16 and 16 are available for filling by conveyor 12. The conveyor is shown in position in which it is filling container 16. Control system 70 is responsive at least to product level sensing means 54, for controlling the conveyor distal end height, to maintain the conveyor distal end close to the product level within the container, so that preforms drop only a short distance from the conveyor into the container. Controller 70 receives product height information from sensor system 54 over line 73. In response, controller 70 sends the appropriate signals over line 78 to the electric linear actuator 30, FIG. 1, to move distal end 13 of conveyor 12 up a sufficient distance to maintain the end at a predetermined distance from the sensed top of the growing pile of preforms in container 16.

Preforms are loaded onto conveyor 12 by transfer conveyor 62 that carries the preforms from the molding machine and deposits them in hopper 14, FIG. 1. When container 16 has been sufficiently filled, control system 70 sends the appropriate signals over line 76 to transfer cylinder 64 that moves conveyor 12 to position 72 (shown in phantom, in which its distal end is located over second container 16). Conveyor 12 pivots on point 40. Controller 70 would then enable the electric linear actuator 30 to drop distal end 13 of conveyor 12 down close to the bottom of empty container 16. Operators could then remove full container 16 and replace it with a new empty container. In this manner, the conveyor system of the invention can continuously convey preforms from a molding machine to a storage container, for their later provision to a blow molding machine to finish the bottle production process.

In order to accurately track the number of preforms deposited into the containers during the container filling process, it is necessary to insure that the preforms are not lost between the molding machine and the containers. The molding machines typically track the quantity of molded parts. To ensure that all these parts make it into a container, the system of this invention preferably includes means for adjusting the speed of the conveyor belt, as further explained below. Also, conveyor 12 has cover 38 that prevents parts from leaving the conveyor except at distal end 13. Conveyor 12 preferably has an exposed belt width of 18 inches, an incline length of about 8 feet, and a distal section decline length of about 4 feet. Conveyor 12 is preferably made of heavy-duty, 11 gauge CRS frame construction, with a rigid, one-piece frame and slider bed. It also preferably includes a “V” guide belt tracking system to ensure proper belt alignment, and sturdy tapered and grooved steel rollers designed for maximum traction, along with long-life, self-aligning bearings. Conveyor 12 preferably also includes stainless steel side rails that overlap the belt by about one inch to help prevent part damage. Cover 38 is preferably polycarbonate so that the interior of the conveyor can be inspected from the outside. This cover also keeps the preforms from tumbling along the conveyor length, and maintains the preforms within the confines of the conveyor until the distal end. The conveyor belt may be driven with a one-half horsepower motor. A right angle gear reducer with a variable speed motor cari be used, to provide the desired variable conveyor speed. The conveyor belt may be made of a PVC anti-static food grade belting material, with one and one-half inch high cleats spaced on nine inch centers. These cleats help to convey the product up the incline section of the conveyor, and prevent the product from tumbling down the decline section of the conveyor.

In order to insure that all the preforms are deposited into a container rather than spilling on the floor when the conveyor is pivoted from one conveyor to another, when the container is almost full, controller 70 preferably sends appropriate signals over line 74 to the conveyor drive motor (not shown) to speed the conveyor belt this quickly clears all of the counted parts from the molding machine into the container before the automatic switchover to a new, empty container is made. When this clearing is complete, controller 70 preferably then automatically slows the belt so that preforms are not deposited from the conveyor while it is being moved from the full to the empty container. This permits the output of the molding machine to be accumulated within the conveyor during the transfer. When the transfer is complete, the belt is returned to its standard speed.

Other embodiments will occur to those skilled in the art and are within the following claims:

What is claimed is:

1. A soft drop preform conveyor system for loading preforms into an open-top container, comprising:
a conveyor having a preform loading end, and a distal end from which preforms leave the conveyor, the conveyor moving preforms from outside of the container, over the lip of the container, and down into the container, close to the product level within the container;
means for sensing the product level height within the container;
means for altering the height of the distal end of the conveyor, between a lowest position in which the distal end is near the bottom of the container, and a highest position in which the distal end is higher within the container, or just above the container; and
a control system, responsive to the product level sensing means, for controlling the conveyor distal end height, to maintain the conveyor distal end close to the product level within the container, so that preforms drop only a short distance from the conveyor into the container.

2. The conveyor system of claim 1 wherein the means for sensing comprises an ultrasonic sensor system.

3. The conveyor system of claim 1 wherein the means for altering comprises an electric linear actuator.

4. The conveyor system of claim 1, further comprising at least two containers proximate one another.

5. The conveyor system of claim 4, further comprising means for moving the conveyor such that its distal end can be located within either container.

6. The conveyor system of claim 5 wherein the means for moving comprises means for pivoting the conveyor about an axis.

7. The conveyor system of claim 1 wherein the conveyor loading end is below the top of the container.

8. The conveyor system of claim 7 wherein the conveyor has a proximal section conveying preforms up over the lip of the container, and a distal section conveying preforms down into the container.

9. The conveyor system of claim 1 wherein the conveyor has a conveyor belt.

10. The conveyor system of claim 9, further comprising means for adjusting the speed of the conveyor belt.

11. The conveyor system of claim 5 wherein the conveyor has a conveyor belt, and further comprising means for adjusting the speed of the conveyor belt to run temporarily faster when a container is almost full, to clear preforms from the container.

12. The conveyor system of claim 11 wherein the means for adjusting further adjusts the conveyor belt speed to run temporarily slower after running temporarily faster, to accumulate preforms in the container while the conveyor distal end is being moved between containers.

13. The conveyor system of claim 9 wherein the conveyor includes side rails partially overlapping the conveyor belt.

14. The conveyor system of claim 9 wherein the conveyor includes a belt cover extending over at least most of the belt length.

15. The conveyor system of claim 1 further comprising a product inception hopper for guiding preforms into the conveyor.

16. The conveyor system of claim 1 wherein the control system delivers a known quantity of preforms into the container.

17. A soft drop preform conveyor system for loading preforms into an open-top container, comprising:
at least two containers proximate one another;
a conveyor having a preform loading end, and a distal end from which preforms leave the conveyor, the conveyor moving preforms from outside of the container, over the lip of the container, and down into the container, close to the product level within the container;
an ultrasonic sensor system for sensing the product level height within the container;
an electric linear actuator system for altering the height of the distal end of the conveyor, between a lowest position in which the distal end is near the bottom of the container, and a highest position in which the distal end is higher within the container, or just above the container;
means for moving the conveyor such that its distal end can be located within either container; and
a control system, responsive to the product level sensing means, for controlling the conveyor distal end height, to maintain the conveyor distal end close to the product level within the container, so that preforms drop only a short distance from the conveyor into the container.

18. The conveyor system of claim 17 wherein the means for moving comprises means for pivoting the conveyor about an axis.

19. The conveyor system of claim 17 wherein the conveyor loading end is below the top of the container.

20. The conveyor system of claim 19 wherein the conveyor has a proximal section conveying preforms up over the lip of the container, and a distal section conveying preforms down into the container.

21. The conveyor system of claim 17 wherein the conveyor has a conveyor belt.

22. The conveyor system of claim 21, further comprising means for adjusting the speed of the conveyor belt.

23. The conveyor system of claim 17 wherein the conveyor has a conveyor belt, and further comprising means for adjusting the speed of the conveyor belt to run temporarily faster when a container is almost full, to clear preforms from the container.

24. The conveyor system of claim 23 wherein the means for adjusting further adjusts the conveyor belt speed to run temporarily slower after running temporarily faster, to accumulate preforms in the container while the conveyor distal end is being moved between containers.
